(19) United States
(12) Patent Application Publication
(10) Pub. No.: US 2011/0253331 A1
(43) Pub. Date: Oct. 20, 2011

(54) MIXTURE, COMPOSITION AND PROCESS FOR SURFACE TREATMENT OF PAPER

(75) Inventors: Paolo ALIOLI, Bergamo BG (IT); Ludwig Haas, Weil der Stadt (DE); Marco Petri, Bergamo BG (IT)

(73) Assignee: 3V Sigma S.p.A., Milano (IT)

(21) Appl. No.: 13/085,013

(22) Filed: Apr. 12, 2011

(30) Foreign Application Priority Data
Apr. 19, 2010 (IT) MI2010A000662

(51) Int. Cl. D21H 23/28; C09K 11/06; C09D 5/00; C08K 5/3492

(52) U.S. Cl. 162/158; 524/100; 252/301.23; 106/287.2

(57) ABSTRACT

The present invention relates to a mixture comprising at least one fluorescent whitening agent and at least one chelating agent, a composition for the surface treatment of paper or cardboard comprising said mixture, a process for the treatment of paper or cardboard by means of said composition and paper or cardboard obtainable through said process.

This application claims the benefit of priority from Italian Patent Application No. MI2010A000662, filed Apr. 19, 2010, the contents of which are incorporated herein by reference.

### FIELD OF THE INVENTION

The present invention relates to a particular mixture for the preparation of a composition for the surface treatment of paper or cardboard, in particular for size press treatment, and a process for surface treatment of paper and cardboard that uses said composition.

### BACKGROUND OF THE INVENTION

It is known that the surface treatment of paper in size press, also known as size press treatment, has the purpose of leveling the properties of sorption of liquids, such as water, oils and inks and to strengthen the cohesion amongst fibers in order to avoid dusting, i.e. the phenomenon of surface fiber detachment during pressing.

Said surface treatments consist in the application on the paper or cardboard sheet surface of one or more uniform layers of water solutions based on a binder, such as starch, which may often comprise a wide number of additives, such as sizing agents, natural pigments, adhesives and fluorescent whitening agents, which allow to improve the optical qualities of the obtained paper.

Processes and products that join the surface treatment of paper and the addition of whitening agents, suitable for improving the optical qualities and in particular the grade of whiteness, are already known.

Further, it is known from U.S. Pat. No. 6,207,258 a composition for surface treatment of paper comprising a divalent metal salt in order to improve inkjet printability of the paper.

At present, the use of solutions for size press treatment comprising said salts, and particularly calcium chloride, is predominant in the paper industry, however a side effect of these additives is a reduction of the yield of the whitening agents which has as a consequence a reduction of the fluorescence of paper and a shifting of the color from blue-violet to yellow-green.

Publication EP2135997 discloses a composition for size press surface treatment of paper comprising at least one specific stilbene-type fluorescent whitening agent having taurine substituents, at least one divalent metal salt, at least one carrier, preferably starch, and water.

In addition, EP0899373 discloses a process for pulp whitening comprising adding fluorescent whitening agents and optionally also chelants to a aqueous slurry comprising the pulp.

WO06/110751 discloses a method for preparing a whitened pulp having an enhanced brightness and a higher resistance against yellowing due to thermal factors, comprising contacting said pulp with an efficient quantity of reducing agents, optionally in combination with whitening agents and/or chelating agents. A synergic effect of the combination between reducing agents and whitening agents is described.

### SUMMARY OF THE INVENTION

It is therefore an object of the present invention to provide a mixture, a composition and a method for size press surface treatment of paper of paper and cardboard, which allows obtaining an increased grade of whiteness of the paper and a reduced tendency to yellowing of the paper itself in the presence of divalent metals, in particular calcium chloride.

Said object is achieved with a mixture comprising at least one fluorescent whitening agent, at least one chelating agent and water, a composition for the surface treatment of paper comprising said mixture and at least one binder, a process for the surface treatment of paper or paperboard wherein a cellulose sheet is put in contact with said composition, and paper or paperboard obtainable through said process.

Surprisingly, it was found that the mixture according to the present invention, which is formed of at least one fluorescent whitening agent and at least one chelating agent, and possibly other additives such as polyvinylalcohol (PVA), polyalkylenglycoles or mixtures thereof, when it is incorporated in a composition for the size press surface treatment, allows the treated paper to reach a higher whiteness and a lower tendency to yellowing, with respect to a composition containing the same quantity of whitening agents and optionally chelating agents, which has not been obtained by incorporating a mixture according to the invention into the composition for size press surface treatment.

### BRIEF DESCRIPTION OF THE DRAWINGS

Further advantages and features of the composition, process and paper according to the present invention will become clear to those skilled in the art from the following detailed and non-limiting description of an embodiment thereof with reference to the attached drawings, wherein:

FIG. 1 shows the results of example 7 comparing the whiteness values of size press compositions according to the state of the art and according to the invention, containing an optical whitening agent of formula 2;

FIG. 2 shows the results of example 8 comparing the whiteness values of size press compositions according to the state of the art and according to the invention, containing an optical whitening agent of formula 2;

FIG. 3 shows the results of example 9 comparing the whiteness values of size press compositions according to the state of the art and according to the invention, containing an optical whitening agent of formula 2;

FIG. 4 shows the results of example 10 comparing the whiteness values of size press compositions according to the state of the art and according to the invention, containing an optical whitening agent of formula 2;

FIG. 5 shows the results of example 11 comparing the whiteness values of size press compositions according to the state of the art and according to the invention, containing an optical whitening agent of formula 3;

FIG. 6 shows the results of example 12 comparing the whiteness values of size press compositions according to the state of the art and according to the invention, containing an optical whitening agent of formula 2;

FIG. 7 shows the results of example 13 comparing the whiteness values of size press compositions according to the state of the art and according to the invention, containing an optical whitening agent of formula 4;

FIG. 8 shows the results of example 14 comparing the whiteness values of size press compositions according to the state of the art and according to the invention, containing an optical whitening agent of formula 2;

FIG. 9 shows the results of example 15 comparing the whiteness values of size press compositions according to the state of the art and according to the invention, containing a optical whitening agent of formula 2,

FIG. 10 shows the results of example 17 comparing the whiteness values of size press compositions according to the state of the art and according to the invention, containing a optical whitening agent of formula 2.

### DETAILED DESCRIPTION OF THE INVENTION

In a first aspect thereof, the present invention relates to a mixture preliminary for the preparation of a composition for the surface treatment of paper, in particular a size press treatment, which comprises water, at least one fluorescent whitening agent and at least one chelating agent.

Under the term “chelating agent”, in the present description is meant any compound capable of forming stable complexes with atoms and metal ions. Chelating agents that may be used in the mixture according to the present invention include organic phosphonates, phosphates, carboxylic acids, dithiocarbamates, and salts or mixtures thereof.

In the present description and in the claims, by “organic phosphonates” the organic derivatives of phosphonic acid, such as for example 1-hydroxyethan-1,1-diphosphonic acid (HEDP), amino tri(methylene phosphonic acid) (ATMP), diethylene triamine penta (methylene phosphonic acid) (DTPMP), polyamino polyether methylene phosphonic acid (PAPEMP), hexamethylene diamino tetra(methylene phosphonic acid) (HMDTMP), hydroxyethylimino bis(methylene phosphonic acid) (EDTMP), nitrilo tris (methylene phosphonic acid) (NTMP) and analogues, are meant.

By “organic phosphates” the organic derivatives of phosphoric acid P(O)(OH)₃, such as for example triethanolamine phosphoric triester (N(CH₂CH₂OP(O)(OH)₂)₃), and analogues, are meant.

By “carboxylic acids” the organic compounds comprising one or more carboxylic groups, such as for example ethylendiaminotetraacetic acid (EDTA), diethylenetriaminopentaacetic acid (DTPA), hydroxyethyl ethylenediamine tetraacetic acid (HEDTA), triethylene tetramine hexaacetic acid (TTHA), dicarboxylmethyl glutamic acid (GLDA), ethanoldiglycinic acid, 1,3-propandiamino tetracetic acid (PDTA), 1,3-diamino-2-hydroxypropan tetracetic acid (DTPA-OH), glycoletherdiamine tetraacetic acid (GEDTA), trans-1,2-diamine cyclohexan-N,N,N′,N′-tetracetic acid (CyDTA), 1-(4-aminobenzyl)ethylenediamine N,N,N′,N′-tetracetic acid, N-(2-acetamido)iminodiacetic acid, 1-(4-isothiocyanatobenzyl)ethylenediamine-N,N,N′,N′-tetraacetic acid and analogues, as well as their salts, are meant.

By “dithiocarbamates”, monomeric or polymeric dithiocarbamates are meant, such as for example disodium dimethyldithiocarbamate, and analogues.

In an embodiment of the present invention, said chelating agent is selected in the group consisting of EDTA, DTPA, HEDTA, GLDA, EDG and PDTA.

Preferably, the mixture according to the present invention comprises said chelating agent in a weight quantity between 0.1% and 10% with respect to the mixture, including water. More preferably, said chelating agent is comprised in the mixture in a weight quantity between 0.4% and 2% with respect to the mixture.

The fluorescent whitening agent that can be used in the mixture according to the invention may be any whitening agent known for size press paper treatment. Preferably, said fluorescent whitening agent is a tetrasulphonated, hexasulphonated, or octasulphonated stilbene derivative or mixtures thereof.

More preferably, said fluorescent whitening agent is a compound having the following formula 1:

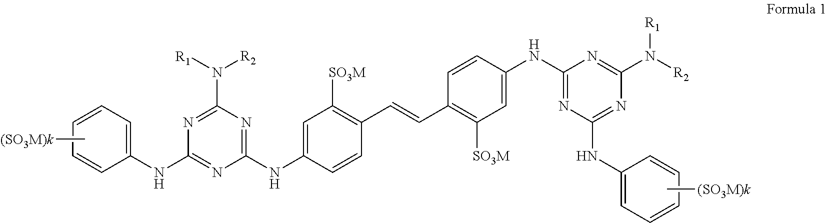

wherein M is selected in the group consisting of H, Li, Na, K, ammonium, and (C₁-C₄ alkyl or C₂-C₄ hydroxyalkyl)mono-, di-, tris- or tetra-substituted ammonium;

k is 1 or 2;

R₁ and R₂ are selected in the group consisting of H, C₁-C₆ straight-chain or branched-chain alkyl groups, C₁-C₆ straight-chain or branched-chain cycloalkyl groups, C₂-C₆ straight-chain or branched-chain hydroxyalkyl groups, C₁-C₆ straight-chain or branched-chain alkoxy groups, C₁-C₆ straight-chain or branched-chain alkylsulphonic groups, C₁-C₆ straight-chain or branched-chain alkylcarboxylic groups, C₁-C₆ straight-chain or branched-chain alkylcarboxamide groups, and C₁-C₆ straight-chain or branched-chain nitrile groups, or groups R₁ and R₂ form, together with the N atom, a heterocyclic ring optionally comprising other heteroatoms.

For example, R₁ ed R₂ may be a methyl, ethyl, n-propyl, i-propyl, n-butyl, t-butyl, i-butyl, 2-hydroxyethyl, 2-hydroxypropyl, 3-hydroxypropyl, 3-hydroxybutyl, ethansulphonyl, 2-amino-1,4-butanedioic, propanamide group.

Alternatively, R₁ and R₂ form, together with the nitrogen atom to which they are bound, a morpholine or piperidine ring.

Even more preferably, the fluorescent whitening agent used in the mixture according to the present invention is selected in the group consisting of the following specific compounds of Formula 2, Formula 3, Formula 4 and Formula 5:

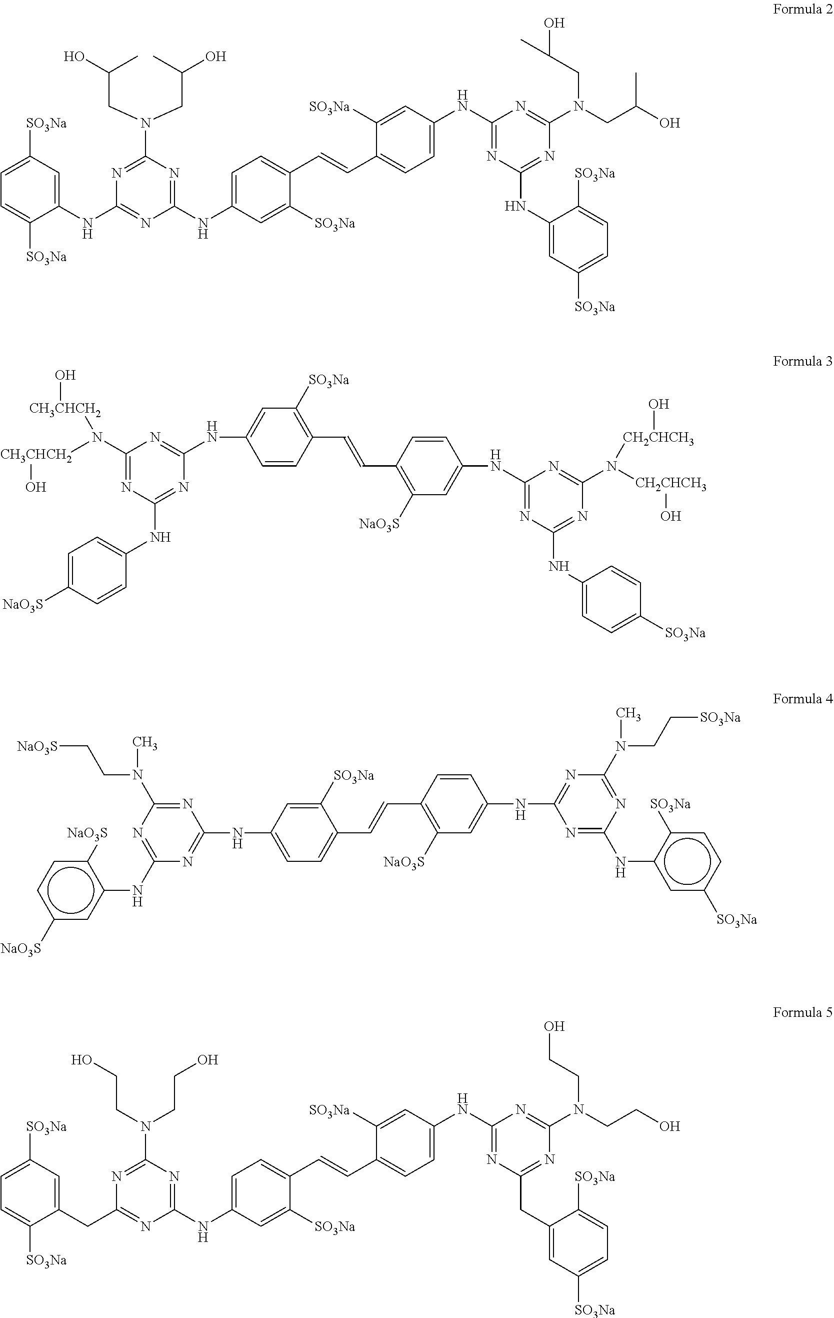

The fluorescent whitening agents that may be used in the mixture according to the present invention can be obtained according to known methods, as described, for example, in patents GB-A 896533 or EP-A 860437. For example, a possible synthesis comprises reacting about 2 moles of cyanuric chloride, about 1 mole of 4,4′-diaminostilbene-2,2′-disulphonic acid, or a salt thereof, about 2 moles of sulphanilic acid or a salt thereof, or 2 moles of aniline-2,5-disulphonic acid or a salt thereof and about 2-2,5 moles of amines corresponding to the substituents R₁ and R₂ of formula 1. At the end of the reaction, the raw solution of the optical whitener can be desalted, for example by suitable membrane separation means and concentrated as described in patent EP-A-992547.

The preferred methods for membrane separation are ultrafiltration, diffusion dialysis and electrodialysis. However, the resulting whitening agent may also be isolated as a solid, for instance by salting or by acid addition. the formed solid may be isolated, for instance, on a filter press and further purified by washing.

Water solutions may also be prepared from raw solutions, concentrated and desalted solutions.

The mixture according to the present invention may also comprise further additives such as polyvinyl alcohol (PVA), polyalkylene glycols or mixtures thereof.

In a second aspect thereof, the invention relates to a composition for paper surface treatment, in particular for size press treatment, comprising the above described mixture of fluorescent whitening agent and chelating agent, besides a binder known for use in compositions for paper treatment.

Any binder known for use in size press treatment compositions may be used as binder for the composition according to the present invention. Examples of suitable binders include natural and modified starches, such as corn starch, potato starch, tapioca starch, or wheat starch; carboxymethylcellulose (CMC) or mixtures thereof. Preferably, the binder is starch and may be comprised in the composition in an amount between 1% by weight and 30% by weight, more preferably between 6% and 12% by weight.

The composition according to the present invention may also advantageously comprise a divalent metal salt, in order to improve inkjet printability of the paper products.

The divalent metal salt in the composition according to the present invention may be any salt usable to this purpose, for example an alkaline earth metal salt and particularly of calcium or magnesium. Preferably, the counterions of the divalent cations are mono- or multi-valent anions such as halogen, sulphate, hydrosulphate, phosphate, hydrophosphate, dihydrophosphate, carbonate, hydrocarbonate, nitrate, acetate, or mixtures thereof. More preferably, calcium chloride, magnesium chloride or mixtures thereof are used.

The composition for paper surface treatment according to the present invention may also comprise further additives known in the art, such as stabilising agents, such as urea, propylene glycol, or glycerol; dispersing agents, preservatives, antifoaming agents and pH correctors.

For the preparation of the composition according to the present invention, a mixture comprising the chelating agent and the fluorescent whitening agent, and optionally other additives such as polyvinyl alcohol (PVA), polyalkylene glycols or mixtures thereof, but lacking the other components of the compositions for size press treatment such as the above defined binders and the divalent metal salts, is first obtained. Said mixture is then combined with the further components of the composition according to the present invention. As a matter of fact, it has been surprisingly found that, in this way, the efficiency of the fluorescent whitening agent in size press uses is remarkably improved, as it is proved by the following examples.

In a preferred embodiment thereof, the invention relates to a composition that is obtainable through a process that comprises the following steps:
preparing a mixture of said at least one fluorescent whitening agent and said at least one chelating agent; and
combining said mixture with said binder and optionally said divalent metal salt.

Once applied on paper or cardboard in size press treatment, the compositions obtainable through said process according to the present preferred embodiment of the invention allow obtaining a whiteness degree of the paper or cardboard that are higher than those that can be reached with compositions according to the known art, but also than those that can be reached with compositions comprising the same components, but obtained through processes that do not comprise preliminary mixing the florescent whitening agent and chelating agent. Without wishing to limit the invention to any theory, the inventors deem that said preliminary mixing allows an interaction between said two components of the mixture, for example formation of a complex.

In this way, the assessment of the whiteness degree of a paper and the correlation of said whiteness degree with the kind of whitening agent used for the size press surface treatment and with the amount of divalent metal salt will be indicative to judge if the mixtures, compositions or the processes according to the invention have been used in order to obtain said paper. As a matter of facts, as it will be shown in the following examples having illustrative and not limitative value, the compositions obtained starting from the mixture according to the invention allow obtaining a higher degree of whiteness than the compositions according to the known art, whitening agent and divalent metal salt concentration being equal.

In said examples, the concentrations of the fluorescent whitening agents are generally characterized by the parameter E^{1%}_{1cm}, which corresponds to the value of the extinction of a composition containing 1% of a whitening agent, determined at the wavelength of the maximum absorption with an optical path length of 1 cm.

The values of E^{1%}_{1cm} of the solutions of fluorescent whitening agents used in the compositions according to the invention are preferably comprised between 50 and 180 and more preferably between 60 and 140.

### EXAMPLES

All the indicated percentages are weight percentages, except where differently indicated.

The assessment of the whiteness degrees D65 Brightness, D65 CIE Whiteness and of the colorimetric coordinates of the system CIE-LAB L, a and b was carried out by using a reflectometer ELREPHO LWE450-X Datacolor, according to the rules ISO 2470-2 and ISO 11475.

### Example 1

### Preparation of Mixture 1 and Mixture 4

A 50% solution of Dissolvine® NA (EDTA, tetra sodium salt in powder, produced by Akzo Nobel Functional Chemicals by) was added under stirring to an industrial preparation of optical whitener having above identified formula 2 (Optiblanc® XL of the company 3V Sigma S.p.A.) until the content of EDTA in the mixture was 0.9% for mixture 1 and 2.5% for mixture 4; both mixtures were formulated to final E^{1%}_{1cm} of 68.0.

### Example 2

### Preparation of Mixture 2

Dissolvine® E39 (EDTA, tetra sodium salt 40% solution, produced by Akzo Nobel Functional Chemicals by) was added under stirring to an industrial preparation of optical whitener having above identified formula 2 (Optiblanc® XL of the company 3V Sigma S.p.A.) until the content of EDTA in the mixture was 1.5% and the final value of E^{1%}_{1cm} was 68.0.

### Example 3

### Preparation of Mixture 3

Dissolvine® G38 (glutamic acid, tetrasodium salt 40% solution produced by Akzo Nobel Functional Chemicals by) was added under stirring to an industrial preparation of optical whitener having above identified formula 2 (Optiblanc® XL of the company 3V Sigma S.p.A.) until the content of GLDA in the mixture was 1.5% and the final value of E^{1%}_{1cm} of the mixture was of 68.0.

### Example 4

### Preparation of Mixture 5

Dissolvine® E39 (EDTA, tetra sodium salt 40% solution, produced by Akzo Nobel Functional Chemicals by) was added under stirring to an industrial preparation of optical whitener having above identified formula 2 (Optiblanc® XL of the company 3V Sigma S.p.A.) until the content of EDTA in the mixture was 1.0%.

Subsequently, the obtained product was additioned with 2.0% by weight of polyvinyl alcohol Mowiol® 4-98 (Kremer Pigmente GmbH & Co. KG), previously dissolved at 20% in demineralised water at T≅85° C. The final value of E^{1%}_{1cm} of the mixture was of 68.0.

### Example 5

### Preparation of Mixture 6

Dissolvine® G38 (glutamic acid, tetrasodium salt 40% solution produced by Akzo

Nobel Functional Chemicals by) was added under stirring to an industrial preparation of optical whitener having above identified formula 3 (Optiblanc® AFW/M of the company 3V Sigma S.p.A.) until the content of GLDA in the mixture was 2.0% and was brought to a E^{1%}_{1cm} final value of the mixture was of 100.0.

### Example 6

### Preparation of Mixture 7

A 50% solution of Dissolvine® NA (EDTA, tetrasodium salt in powder produced by Akzo Nobel Functional Chemicals by) was added under stirring to an industrial preparation of optical whitener having above identified formula 4 (Blankophor® CA of the company Kemira) until the content of EDTA in the mixture was 1.0% and was brought to a E^{1%}_{1cm} final value of the mixture was of 65.0.

In the following examples, the dosages of the fluorescent whitening agents were brought to the same extinction.

Three different supporting papers were used, with different features of whiteness grade and internal sizing (expressed through the COBB value determined by the method UNI 6437).

The following table A gives optical properties and COBB of supporting paper 1 (used in examples 7, 9 and 12, 14, 15 and 17) and of supporting paper 2 (used in example 8) and of supporting paper 3 (used in examples 10, 11, and 13).

TABLE A
Examples 7, 9, 12, 14, 15, 17

| | D65 brightness | | | D65 CIE | | | | |
|---|---|---|---|---|---|---|---|---|
| support 1 | R457+ | R457− | Delta | whiteness | L* | a* | b* | COBB₆₀ |
| | 95.1 | 87.8 | 7.3 | 102.09 | 97.00 | 1.15 | −2.17 | 25 g/m² |

Example 8

| | D65 brightness | | | D65 CIE | | | | |
|---|---|---|---|---|---|---|---|---|
| support 2 | R457+ | R457− | Delta | whiteness | L* | a* | b* | COBB₆₀ |
| | 102.3 | 87.1 | 15.2 | 129.10 | 96.17 | 2.75 | −8.71 | 30 g/m² |

Examples 10, 11, 13

| | D65 brightness | | | D65 CIE | | | | |
|---|---|---|---|---|---|---|---|---|
| support 3 | R457+ | R457− | Delta | whiteness | L* | a* | b* | COBB₃₀ |
| | 106.2 | 89.5 | 16.7 | 138.71 | 96.40 | 3.28 | −10.78 | 80 g/m² |

All the samples were obtained by applying a uniform layer of a composition obtained in the previous examples on the supports by means of a laboratory doctor knife. The medium weight of the dry composition applied on the supports was about 2 g/m². At the end of the application, the samples were dried at room temperature for about one hour.

The amounts of whitening agents are expressed in grams of product per liter of size press composition.

The amounts of calcium chloride (where present) is expressed in grams of dry salt per liter of size press composition.

### Example 7

A size press composition formed of a cornstarch paste Noredux® C15 having final dry content of 6.0% was divided in three parts, which were additioned with different quantities of calcium chloride, respectively of 7.62 g/l, 19.58 g/l, and 26.62 g/l.

Each of the resulting compositions was divided in two parts, which were respectively additioned with:

40 g/l of formula 2 whitener in water solution having final E^{1%}_{1cm} of 68.0; or

40 g/l of mixture 1.

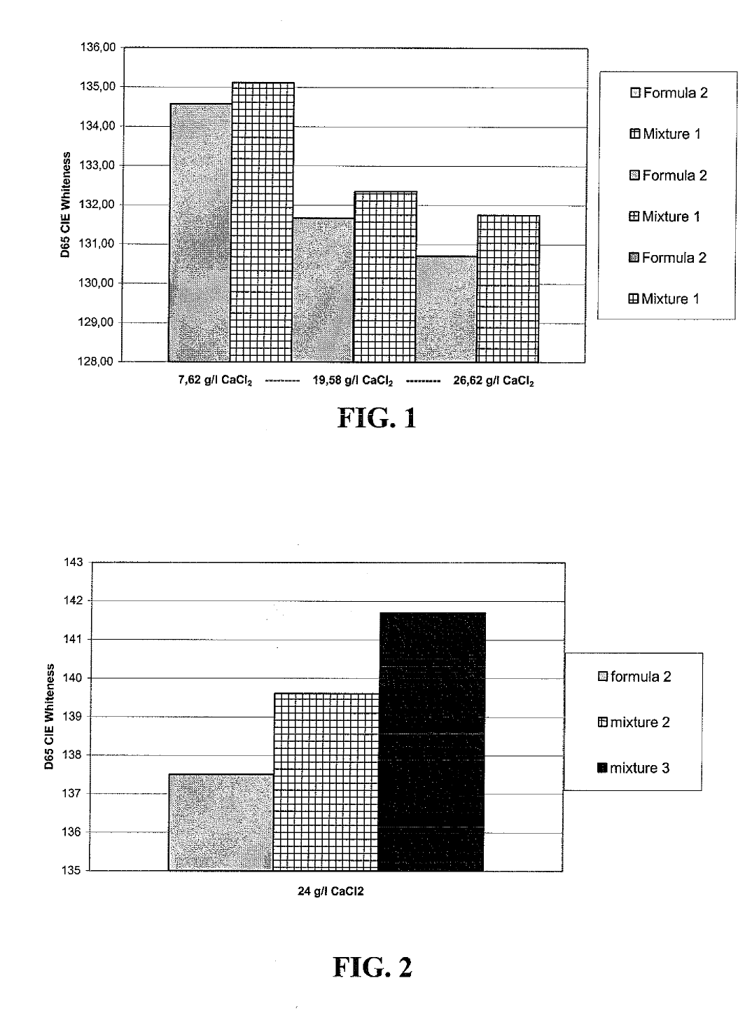

From application of the six resulting compositions on six supports of type 1, were obtained six samples which were subjected to determination of the whiteness grade. The obtained values are given in table 1 and in FIG. 1.

TABLE 1
Example 7

| | | | D65 | D65 | | | |
|---|---|---|---|---|---|---|---|
| Whitening | Sam- | CaCl₂ | brightness | CIE | | | |
| agent | ple | (g/l) | R457+ | whiteness | L* | a* | b* |
| Formula 2 | 1 | 7.62 | 108.1 | 134.57 | 98.20 | 3.01 | −8.96 |
| | 2 | 19.58 | 107.4 | 131.67 | 98.22 | 2.57 | −8.28 |
| | 3 | 26.62 | 107.0 | 130.70 | 98.19 | 2.52 | −8.07 |
| Mixture 1 | 4 | 7.62 | 108.4 | 135.11 | 98.21 | 3.02 | −9.08 |
| | 5 | 19.58 | 107.8 | 132.35 | 98.23 | 2.58 | −8.43 |
| | 6 | 26.62 | 107.6 | 131.75 | 98.25 | 2.50 | −8.28 |

### Example 8

A size press composition formed of a starch paste C*FILM 07312 (of the company Cargill) having final dry content of 10.0% was additioned with 24 g/l of calcium chloride, then divided in three parts to which were subsequently added:

12.35 g/l of formula 2 whitener in water solution having final E^{1%}_{1cm} of 68.0;

12.35 g/l of mixture 2;

12.35 g/l of mixture 3.

From application of the three resulting compositions on three supports of type 2, were obtained three samples which were subjected to determination of the whiteness grade. The obtained values are given in table 2 and in FIG. 2.

TABLE 2

| | | Whitening | D65 | D65 | | | |
|---|---|---|---|---|---|---|---|
| Whitening | Sam- | agent | brightness | CIE | | | |
| agent | ple | amount g/l | R457+ | whiteness | L* | a* | b* |
| formula 2 | 1 | 12.35 | 105.6 | 137.5 | 96.15 | 2.90 | −10.62 |
| mixture 2 | 2 | 12.35 | 106.6 | 139.6 | 96.19 | 2.85 | −11.07 |
| mixture 3 | 3 | 12.35 | 107.3 | 141.7 | 96.11 | 2.76 | −11.59 |

### Example 9

A size press composition formed of a cornstarch paste Noredux® C15 having final dry content of 7.0% was additioned with 36 g/l calcium chloride, then it was divided in two parts which were subsequently additioned with:

29.0 g/l of formula 2 whitener in water solution having final E^{1%}_{1cm} of 68.0; and

29.0 g/l of mixture 4.

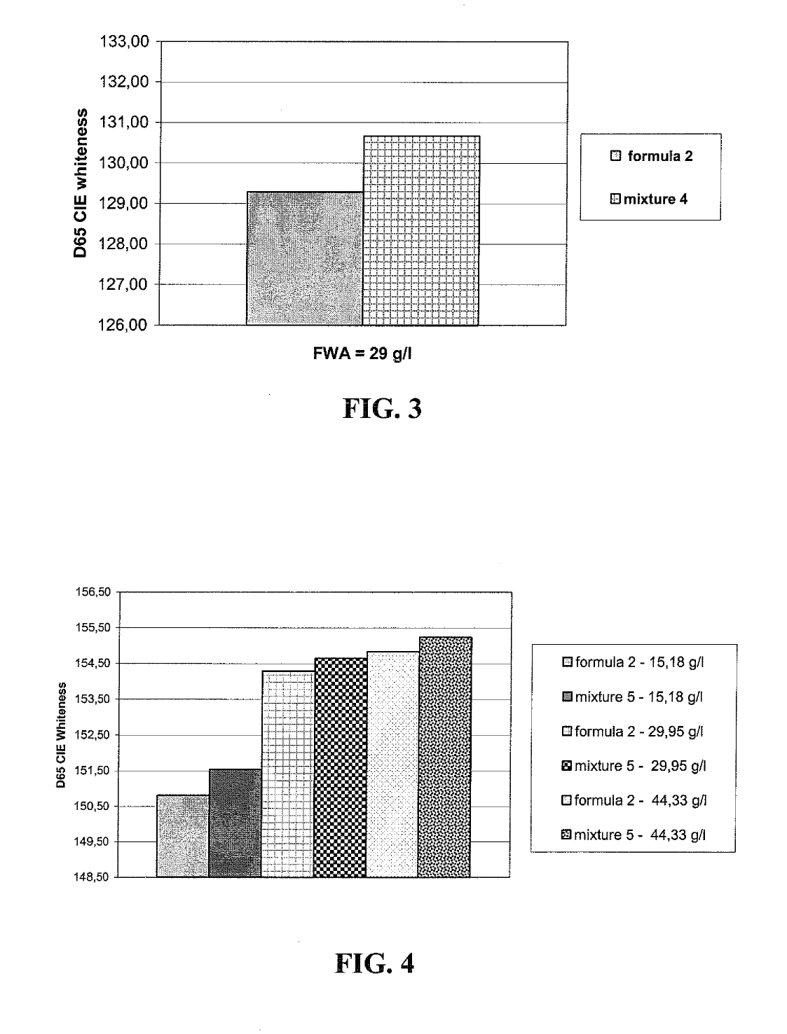

Each of the so obtained compositions was applied on three support 1 paper sheet. Thus, six samples were obtained which were subjected to determination of the whiteness grade. The obtained values are given in table 3 and in FIG. 3.

TABLE 3

| | | Whitening | D65 | D65 CIE whiteness | | |
|---|---|---|---|---|---|---|
| Whitening | Sam- | agent | brightness | | | Delta |
| agent | ple | amount g/l | R457+ | Valore | Average | CIE |
| formula 2 | 1 | 29.00 | 106.6 | 129.30 | 129.29 | |
| | 2 | 29.00 | 106.5 | 129.19 | | |
| | 3 | 29.00 | 106.6 | 129.37 | | |
| miscela 4 | 4 | 29.00 | 106.9 | 130.61 | 130.67 | +1.38 |
| | 5 | 29.00 | 106.9 | 130.56 | | |
| | 6 | 29.00 | 107.0 | 130.83 | | |

### Example 10

A size press composition formed of a cornstarch paste Noredux® C15 having final dry content of 8.0% was additioned with 10 g/l of calcium chloride, then it was divided in 10 parts, which were respectively additioned with:
0.0-15.18-29.95-44.33-58.33 g/l of formula 2 whitening agent in water solution, having final E^{1%}_{1cm} of 68.0; and
0.0-15.18-29.95-44.33-58.33 g/l of mixture 5.

Each of the so obtained compositions was applied on a support 3 paper sheet. So, ten samples were obtained which were subjected to determination of the whiteness grade. The obtained results are given in table 4 and in FIG. 4.

TABLE 4

| | | Whitening | D65 | D65 | | | |
|---|---|---|---|---|---|---|---|
| Whitening | Sam- | agent | brightness | CIE | | | |
| agent | ple | amount (g/l) | R457+ | whiteness | L* | a* | b* |
| formula 2 | 1 | 0.00 | 106.4 | 139.33 | 96.41 | 3.31 | −10.91 |
| | 2 | 15.18 | 111.3 | 150.81 | 96.73 | 3.80 | −13.40 |
| | 3 | 29.95 | 113.1 | 154.29 | 96.87 | 3.74 | −14.14 |
| | 4 | 44.33 | 113.8 | 154.83 | 96.96 | 3.53 | −14.22 |
| | 5 | 58.33 | 113.9 | 154.53 | 97.00 | 3.33 | −14.13 |
| mixture 5 | 6 | 0.00 | 106.4 | 139.33 | 96.41 | 3.31 | −10.91 |
| | 7 | 15.18 | 111.6 | 151.54 | 96.74 | 3.85 | −13.57 |
| | 8 | 29.95 | 113.3 | 154.65 | 96.88 | 3.81 | −14.22 |
| | 9 | 44.33 | 114.0 | 155.24 | 96.95 | 3.65 | −14.32 |
| | 10 | 58.33 | 114.2 | 155.37 | 96.99 | 3.46 | −14.33 |

### Example 11

A size press composition formed of a cornstarch paste Noredux® C15 having final dry content of 12.0% was divided in two parts; one was additioned with 10 g/l of calcium chloride and the other was left unchanged.

The so obtained solutions were also divided in two parts, and each was subsequently additioned with:

6.6 g/l of formula 3 whitening agent in water solution, having final E^{1%}_{1cm} of 100.0; and

6.6 g/l of mixture 6.

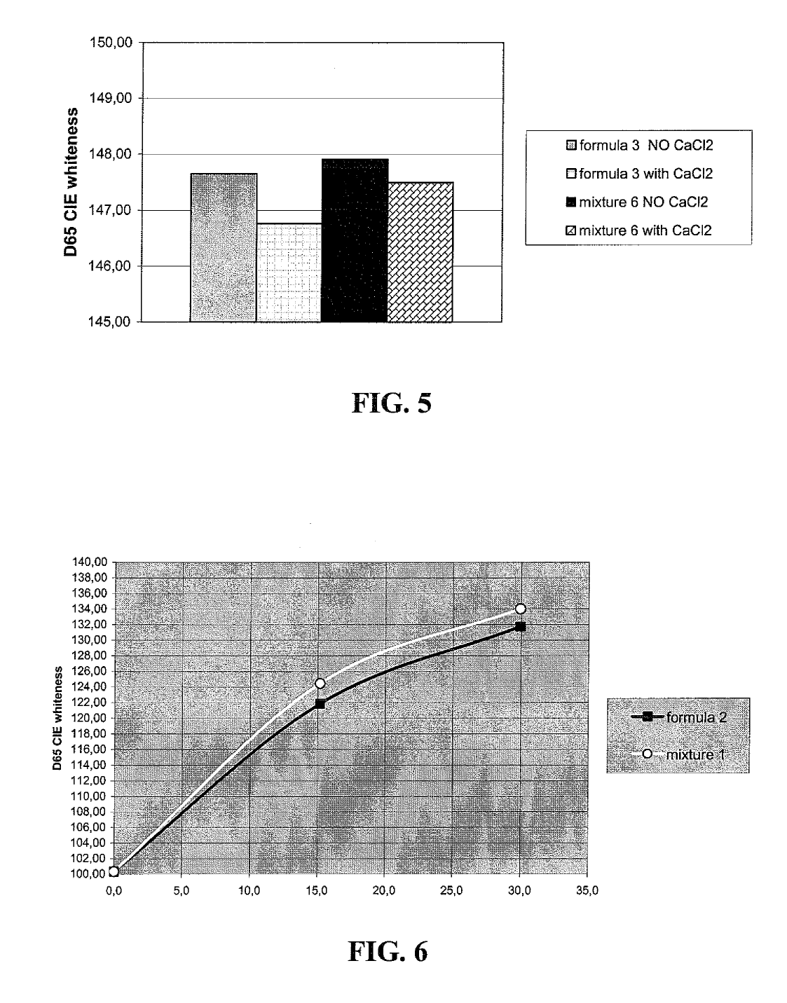

Each of the so obtained compositions was applied on a support 3 paper sheet. The four obtained samples were subjected to determination of the whiteness grade. The obtained results are given in table 5 and in FIG. 5.

TABLE 5

| | | Whitening | CaCl₂ | D65 | D65 CIE whiteness | |
|---|---|---|---|---|---|---|
| Whitening | Sam- | agent | amount | brightness | | Delta |
| agent | ple | amount g/l | g/l | R457+ | Value | CIE |
| formula 3 | 1 | 6.60 | 0.00 | 110.8 | 147.65 | |
| | 2 | 6.60 | 10.00 | 110.4 | 146.76 | −0.89 |
| mixture 6 | 3 | 6.60 | 0.00 | 111.0 | 147.91 | |
| | 4 | 6.60 | 10.00 | 110.5 | 147.50 | −0.41 |

### Example 12

A size press composition formed of a cornstarch paste Noredux® C15 having final dry content of 6.0% was divided in 6 parts, which were respectively additioned with:
0.0-15.18-29.95 g/l of formula 2 whitening agent in water solution, having final E^{1%}_{1cm} of 68.0; and
0.0-15.18-29.95 g/l of mixture 1.

Each of the so obtained compositions was applied on a support paper sheet. So, six samples were obtained which were subjected to determination of the whiteness grade. The obtained results are given in table 6 and in FIG. 6.

TABLE 6

| | | Whitening | D65 | D65 | | | |
|---|---|---|---|---|---|---|---|
| Whitening | Sam- | agent | brightness | CIE | | | |
| agent | ple | amount (g/l) | R457+ | whiteness | L* | a* | b* |
| formula 2 | 1 | 0.00 | 95.2 | 100.32 | 97.34 | 1.34 | −1.58 |
| | 2 | 15.18 | 102.6 | 121.84 | 97.74 | 2.70 | −6.27 |
| | 3 | 29.95 | 106.6 | 131.73 | 98.01 | 3.15 | −8.40 |
| mixture 1 | 4 | 0.00 | 95.2 | 100.32 | 97.34 | 1.34 | −1.58 |
| | 5 | 15.18 | 103.5 | 124.44 | 97.80 | 2.84 | −6.83 |
| | 6 | 29.95 | 107.4 | 133.99 | 98.04 | 3.25 | −8.91 |

### Example 13

A size press composition formed of a potato starch paste Perfectamyl®4692 having final dry content of 6.0% was additioned with 10 g/l of calcium chloride, then it was divided in 2 parts, which were respectively additioned with:
29.0 g/l of formula 4 whitening agent in water solution, having final E^{1%}_{1cm} of 65.0; and
29.0 g/l of mixture 7.

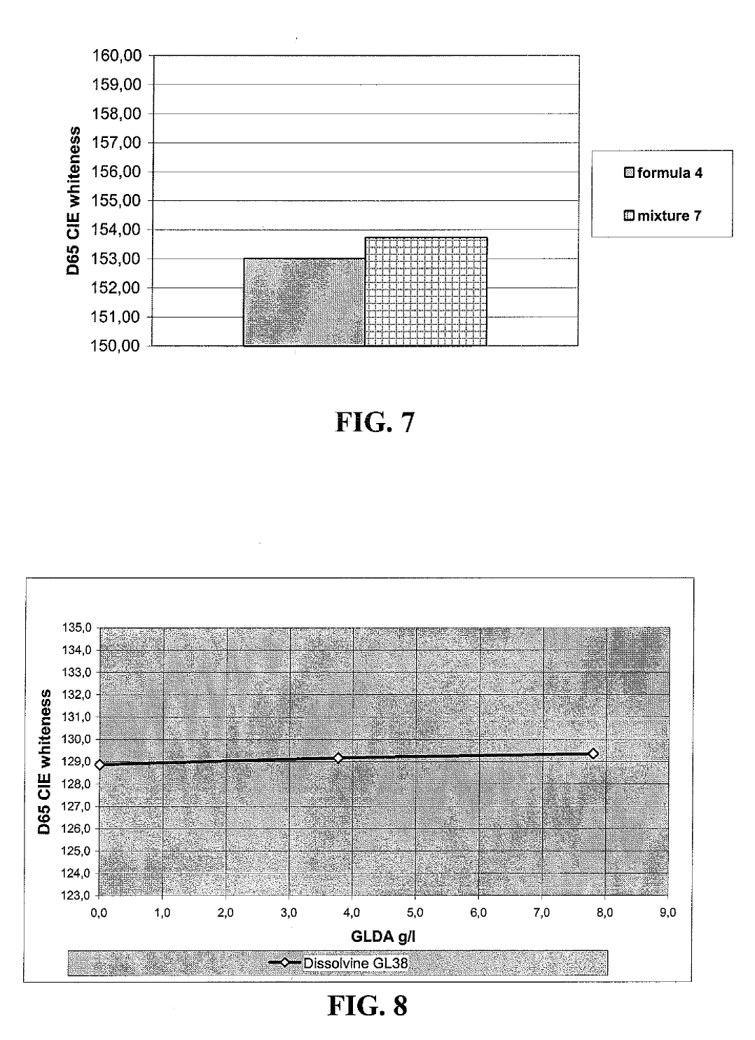

Each of the so obtained compositions was applied on three support 3 paper sheet. So, six samples were obtained which were subjected to determination of the whiteness grade. The obtained results are given in table 7 and in FIG. 7.

TABLE 7

| | | Whitening | D65 | D65 CIE whiteness | | |
|---|---|---|---|---|---|---|
| Whitening | Sam- | agent | brightness | | | Delta |
| agent | ple | amount g/l | R457+ | Value | Average | CIE |
| formula 4 | 1 | 29.00 | 112.6 | 153.28 | 153.01 | |
| | 2 | 29.00 | 112.5 | 152.84 | | |
| | 3 | 29.00 | 112.6 | 152.92 | | |
| mixture 7 | 4 | 29,00 | 112.8 | 153.83 | 153.73 | +0.72 |
| | 5 | 29.00 | 112.8 | 153.64 | | |
| | 6 | 29.00 | 112.8 | 153.73 | | |

### Example 14

A size press solution formed of a cornstarch paste Noredux® C15 having final dry content of 6.0% was additioned with 26.5 g/l of calcium chloride and 40.0 g/l of formula 2 whitening agent in water solution having final E^{1%}_{1cm} of 68.0.

To the so obtained size press composition, the following amounts of Dissolvine G38 (glutamic acid tetrasodium salt 40% solution, produced by Akzo Nobel Functional Chemicals by) were added:

0.0 g/l,-3.77 g/1-7.80 g/l.

The so obtained compositions were applied on support 1 paper. So, three samples were obtained which were subjected to determination of the whiteness grade. The obtained results are given in table 8 and in FIG. 8.

TABLE 8

| | | | D65 | D65 | | | |
|---|---|---|---|---|---|---|---|
| Chelating | Sam- | GLDA | brightness | CIE | | | |
| agent | ple | (g/l) | R457+ | whiteness | L* | a* | b* |
| Dissolvine | 1 | 0.00 | 106.7 | 128.86 | 98.16 | 1.89 | −7.65 |
| GL38 | 3 | 3.77 | 106.8 | 129.16 | 98.17 | 1.88 | −7.72 |
| | 5 | 7.80 | 106.9 | 129.35 | 98.16 | 1.91 | −7.77 |

As it may be inferred from the above resulting data, the increase of the whiteness grade after adding the chelating agents is lower than that obtainable with compositions prepared by premixing the whitening agent with the chelating agent.

### Example 15

A size press solution formed of a cornstarch paste Noredux® C15 having final dry content of 8.0% was additioned with 20 g/l of calcium chloride and 35.0 g/l of formula 2 whitening agent in water solution having final E^{1%}_{1cm} of 68.0.

The obtained size press composition was applied on type 1 support paper. So, samples 1 and 2 were obtained which were subjected to determination of the degree of whiteness.

To remaining size press composition, were added 1 g/l of Dissolvine E39 (EDTA tetrasodium salt, produced by Akzo Nobel Functional Chemicals by); the resulting composition was applied on support 1 paper. So, samples 3 and 4 were obtained which were subjected to determination of the whiteness grade. The obtained results are given in table 9 and in FIG. 9.

TABLE 9

| | | D65 | D65 CIE whiteness | | | | | |
|---|---|---|---|---|---|---|---|---|
| Chelating | Sam- | brightness | | | Delta | | | |
| agent | ple | R457+ | Value | Average | CIE | L* | a* | b* |
| 0 g/l | 1 | 100.3 | 114.97 | 114.99 | | 97.60 | 2.15 | −4.77 |
| Dissolvine | 2 | 100.3 | 115.01 | | | 97.58 | 2.16 | −4.79 |
| E39 | | | | | | | | |
| 1 g/l | 3 | 100.3 | 115.25 | 115.27 | +0.28 | 97.61 | 2.16 | −4.83 |
| Dissolvine | 4 | 100.4 | 115.29 | | | 97.61 | 2.17 | −4.84 |
| E39 | | | | | | | | |

Also in this case, the beneficial effect of the addition of chelating agent in the size press composition is observable, but is lower than that obtainable by means of compositions prepared by premixing the whitening agent with the chelating agent.

### Example 16

### Preparation of Mixture 8

A 36% solution of calcium chloride was added under stirring to an industrial preparation of optical whitener having above identified formula 2 (Optiblanc® XL of the company 3V Sigma S.p.A.) until the content of CaCl₂ in the mixture was 2%. Subsequently, Dissolvine® E39 (EDTA, tetra sodium salt 40% solution, produced by Akzo Nobel Functional Chemicals by) was added under stirring until the content of EDTA in the mixture was 1.5 and the final value of E^{1%}_{1cm} was of 68.0.

### Example 17

A size press solution formed of a cornstarch paste Noredux® C15 having final dry content of 7.0% was additioned with 19.50 g/l of calcium chloride and then divided in three equal parts, which respectively were additioned with:
0.50 g/l of calcium chloride and subsequently 25.0 g/l of formula 2 whitener in water solution having final E^{1%}_{1cm} of 68.0;
0.50 g/l of calcium chloride and subsequently 25.0 g/l of mixture 2;
25.0 g/l of mixture 8.

Therefore, each one of the three so obtained compositions had a CaCl₂ final content of 20.0 g/l. Each composition was then applied on type 1 support paper. Three samples were obtained which were subjected to determination of the degree of whiteness.

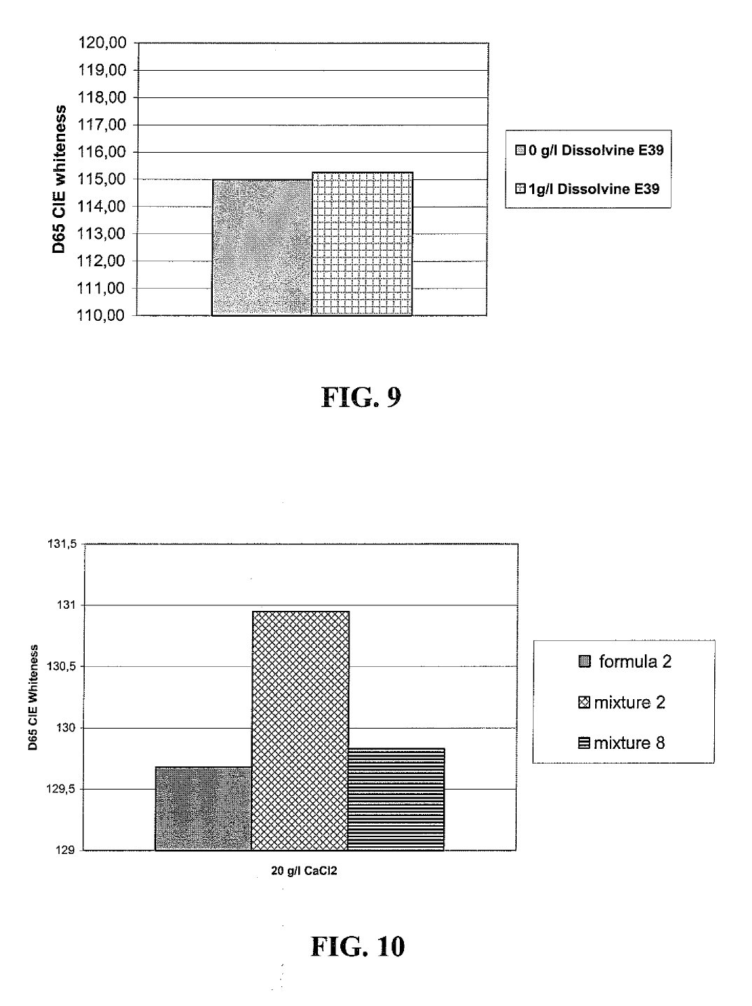

The obtained results are given in table 10 and in FIG. 10.

TABLE 10

| | | FWA | D65 | D65 | | | |
|---|---|---|---|---|---|---|---|
| | sam- | dosage | brightness | CIE | | | |
| FWA | ple | g/l | R457+ | whiteness | L* | a* | b* |
| formula 2 | 1 | 25.0 | 105.3 | 129.68 | 97.58 | 2.44 | −8.14 |
| whitener | | | | | | | |
| Mixture 2 | 2 | 25.0 | 106.0 | 130.95 | 97.68 | 2.48 | −8.39 |
| Mixture 8 | 3 | 25.0 | 105.4 | 129.83 | 97.63 | 2.47 | −8.15 |

Surprisingly again, the composition prepared by premixing the whitening agent with the chelating agent and by subsequently incorporating said premixed agents into the solution of starch and calcium chloride shows a highly improved performance, not only with respect to the composition comprising no chelating agent, but also with respect to that obtained without said premixing step.

1. Mixture comprising a fluorescent whitening agent, water, and a chelating agent.

2. Mixture according to claim 1, wherein said chelating agent is selected from the group consisting of organic phosphonates, phosphates, carboxylic acids, dithiocarbamates, and salts or mixtures thereof.

3. Mixture according to claim 1, wherein said chelating agent is selected from the group consisting of EDTA, DTPA, HEDTA, GLDA, EDG and PDTA.

4. Mixture according to claim 1, wherein said chelating agent is present in a quantity of between 0.1% and 10% by weight.

5. Mixture according to claim 4, wherein said chelating agent is present in a quantity of between 0.4% and 2% by weight.

6. Mixture according to claim 1, wherein said fluorescent whitening agent is a tetrasulphonated, hexasulphonated, or octasulphonated stilbene derivative.

7. Mixture according to claim 6, wherein said fluorescent whitening agent is a compound of formula 1: 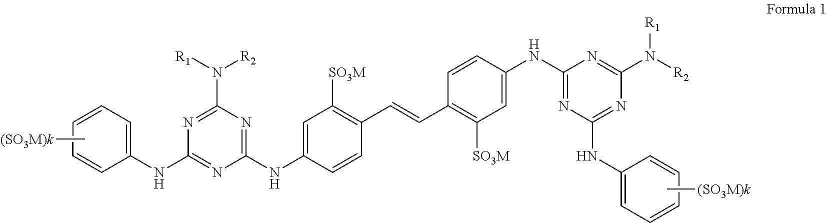
wherein M is selected from the group consisting of the cations of H, Li, Na, K, ammonium, and mono-, bis-, tris-, tetra-substituted ammonium with C₁-C₄ alkyls or C₂-C₄ hydroxyalkyls;
k is an integer equal to 1 or 2;
R₁ and R₂ are selected from the group consisting of H, C₁-C₆ linear or branched alkyl groups, C₁-C₆ linear or branched cycloalkyl groups, C₂-C₆ linear or branched hydroxyalkyl groups, C₁-C₆ linear or branched alkoxy groups, C₁-C₆ linear or branched alkylsulphonic groups, C₁-C₆ linear or branched alkylcarboxylic groups, C₁-C₆ linear or branched alkylcarboxyamide groups, and C₁-C₆ linear or branched nitrile groups or groups R₁ and R₂ form together with the nitrogen atom, a heterocyclic ring optionally comprising further heteroatoms.

8. Mixture according to claim 7, wherein said fluorescent whitening agent is selected from the group consisting of:

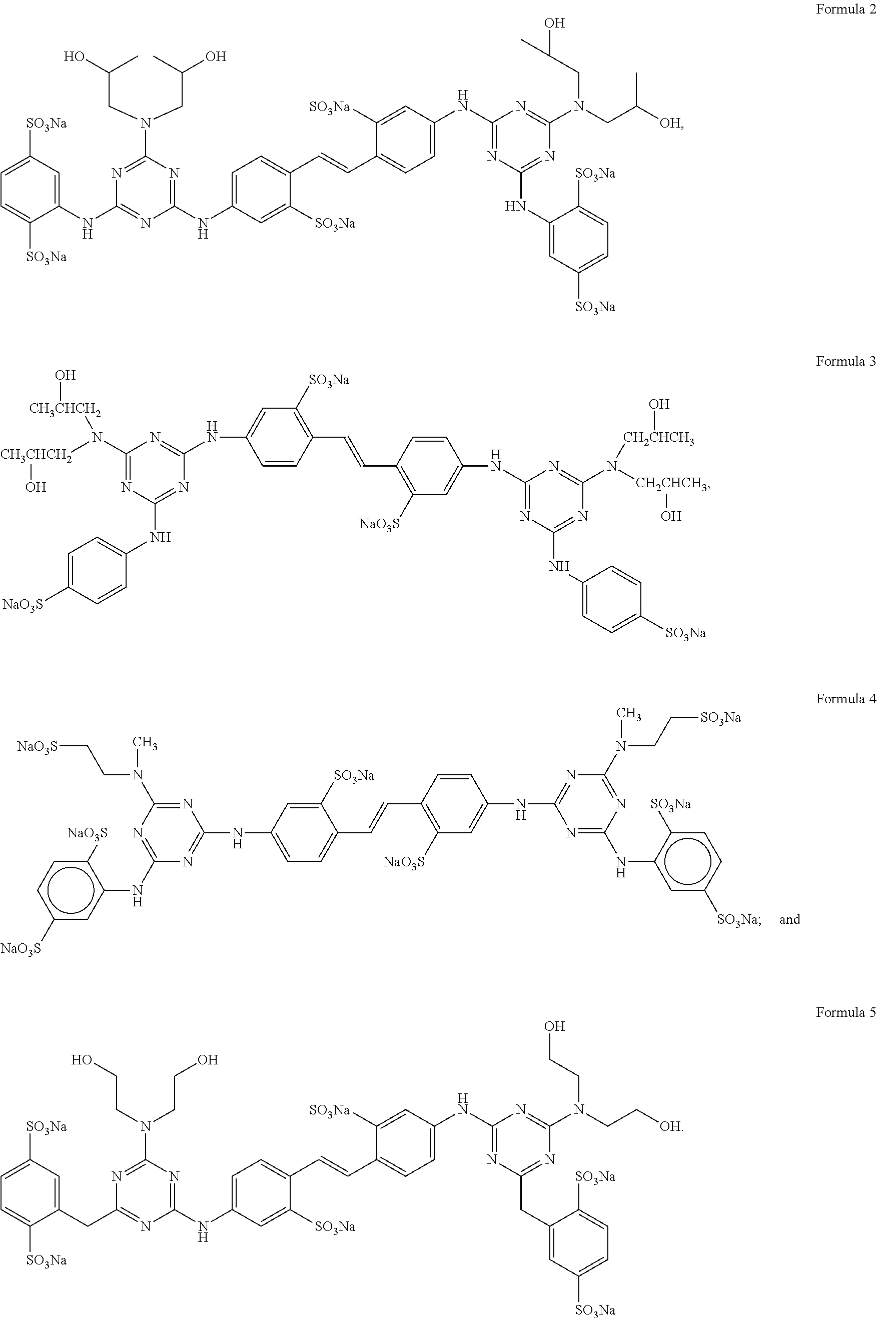

9. Mixture according to claim 1, further comprising polyvinyl alcohol (PVA), polyethylene glycols or mixtures thereof.

10. Composition for surface treatment of paper comprising at least one binder and a mixture according to claim 1.

11. Composition according to claim 10, further comprising at least one divalent metal salt.

12. Composition for the surface treatment of paper prepared by the process of:
preparing a mixture according to claim 1; and
combining said mixture with at least one binder and optionally at least one divalent metal salt.

13. Process for surface treatment of paper or cardboard, wherein a cellulose sheet is contacted with a composition according to claim 10.

14. Process according to claim 13, wherein said contact is carried out in a size press.

15. Paper or cardboard obtainable by the process according to claim 13.
